(19) United States
(12) Patent Application Publication
(10) Pub. No.: US 2009/0170571 A1
(43) Pub. Date: Jul. 2, 2009

(54) METHOD AND APPARATUS FOR PARTIAL FLIP-OPEN ASSIST OF ULTRA THIN CLAM COMMUNICATION DEVICES

(75) Inventors: Rachid Alameh, Crystal Lake, IL (US); Thomas Gitzinger, Libertyville, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 12/183,205

(22) Filed: Jul. 31, 2008

Related U.S. Application Data
(60) Provisional application No. 61/017,925, filed on Dec. 31, 2007.

(51) Int. Cl. H04M 1/02

(52) U.S. Cl. 455/575.3

(57) ABSTRACT

A method and apparatus that minimizes the initial effort spent in opening a flip phone during single handed clam operation is disclosed. The method may include applying an initial horizontal external force to move a rotating subassembly or flip to a first position from a close position, and then applying a vertical external force to move the rotating subassembly to an open position. The movement of the flip can be done through straight or curved guided tracks in the base goal posts area. Flip pins will slide into these tracks for flip open and close operation. The initial horizontal external force moves a base pin so as to unlock the flip from the base housing. The unlocking causes the flip to rotate, a cam spring and cam pin forces the rotation of the flip over a partial angle as set by cam pin profile.

The present application claims priority from U.S. Provisional Patent Application No. 61/017,925 filed Dec. 31, 2007.

### BACKGROUND OF THE INVENTION

1. Field of the Invention

The invention relates generally to closeable devices and, more particularly to hinged closable devices with single handed clam operation.

2. Introduction

In order to push clam phone designs thinner and thinner, a new approach is needed. In current clam-shell phones, the base and flip typically divide the overall thickness over the full length of the phone. This naturally leads to placing the hinge at the top of the phone in the closed position.

If the goal is to push the design thinner, something other than simply shrinking component size (hardware, antenna, materials, etc) needs to be done. Thin profile clam designs present a number of challenges that need to be overcome. Mainly, component fit, housing strength, and single-handed flip open operation. A scheme to resolve these issues has been addressed with the offset hinge design. As to the single-handed flip open operation an offset hinge allow user to grab the phone at the base and by pulling the flip bottom with the index finger to open the flip side. However, the initial pull effort to open the phone from a closed position is difficult for users.

For the reasons stated above, and for other reasons stated below which will become apparent to those skilled in the art upon reading and understanding the present specification, there is a need in the art to minimize the initial effort spent in opening a flip phone during single handed clam operation.

### SUMMARY OF THE INVENTION

A method and apparatus that minimizes and simplifies the initial effort spent in opening a flip phone during single handed operation is disclosed. The method may include applying an initial horizontal external force to move a rotating subassembly or flip to a first position from a closed position, and then applying a vertical external force to move the rotating subassembly to an open position. The movement of the flip can in some other embodiments be done through straight or curved guided tracks in the base goal posts area. Flip pins will slide into these tracks for flip open and close operation. A preferred embodiment which is the focus of this filing uses a spring scheme to partially open flip instead of curved tracks following a horizontal finger press. The initial horizontal external force moves a base locking feature so as to unlock the flip from the base housing. The unlocking causes the flip to become free to rotate, a cam spring and cam pin forces the rotation of the flip over a partial angle as set by cam pin profile.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a horizontal external force being applied to a flip phone in accordance with a possible embodiment of the invention;

FIG. 2 illustrates a partially opened flip phone in accordance with a possible embodiment;

FIG. 3 illustrates a flip closed and cam mechanism for a flip phone in accordance with a possible embodiment of the invention;

FIG. 4 illustrates a flip open and cam mechanism for a flip phone in accordance with a possible embodiment of the invention;

FIG. 5 illustrates a base pin locking feature position in the flip portion of a flip phone in accordance with a possible embodiment of the invention;

FIG. 6 illustrates a base pin locking feature position in the base portion of a flip phone in accordance with a possible embodiment of the invention;

FIG. 7 illustrates a flip guide and unlocked base pin during open position for a flip phone in accordance with a possible embodiment of the invention;

FIG. 8 illustrates cam and pin profile during a partially open position in accordance with a possible embodiment of the invention;

FIG. 9 is an illustration of a locking feature in accordance with a possible embodiment of the invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention. The invention comprises a variety of embodiments, such as a method and apparatus and other embodiments that relate to the basic concepts of the invention.

Below are definitions which will be used throughout in the discussion:

The term “locking mechanism”, is referred to as a locking feature that forces that base and flip to lock in a closed position and unlock prior to opening the flip. The locking feature can be designed as part of the flip or base body.

The term “added spring” is a spring added in the cam chamber to counter the finger press in a first direction or horizontal direction. In the absence of the finger press, the “added spring” pushes the locking feature to lock base and flip in a closed position.

The term “locking feature guide” is a guide inside of which the locking feature slides that could be design as part of base or flip body.

The term “cam spring” is a spring inside the cam and may include two opposite springs. The Cam spring provides the flip open and closed assist and sets the neutral angle.

The “cam pin” is acted on by the cam spring and follower. The Cam pin profile sets the assist flip open angle initial angle, neutral angle, flip open/closed assist, etcetera.

This invention concerns a mechanism for assisting and simplifying the natural motion a user has to engage in when opening a flip phone.

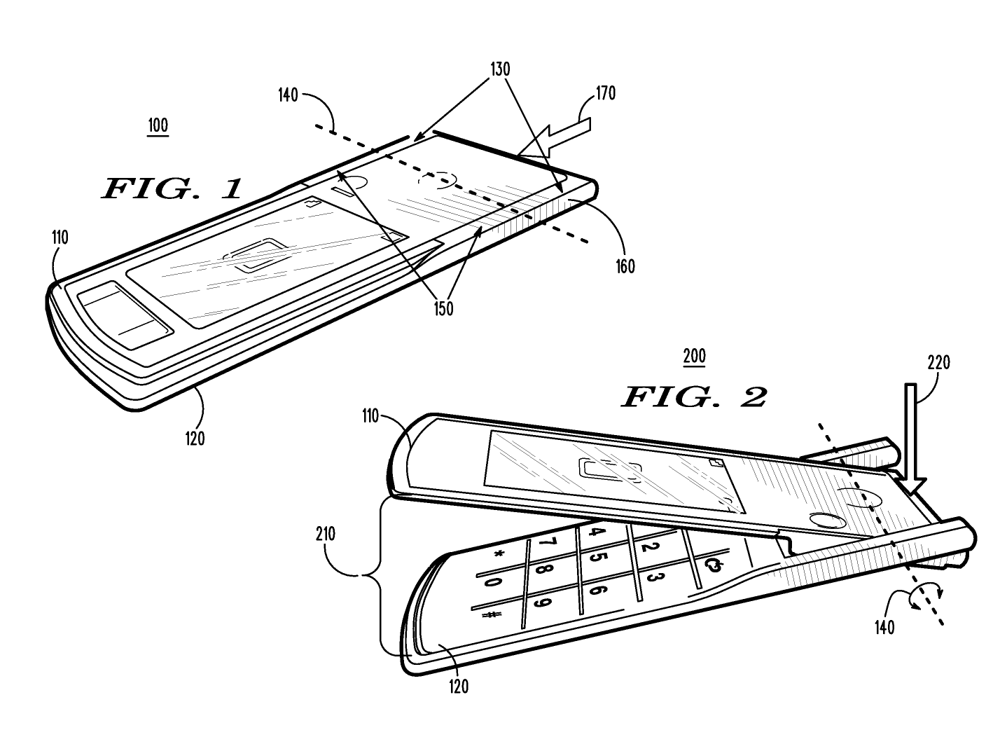

FIG. 1 illustrates an exemplary diagram of a flip phone 100 in accordance with a possible embodiment of the invention. In particular, flip phone 100 includes a first housing 120 or base, a second housing 110 or flip, a hinge mechanism 130, a first mechanism (not shown) for subjecting the respective housings to a holding force, and second mechanism (not shown) for holding the respective housings at a first position or at a partial open state. The flip phone 100 may be a portable MP3 player, communication device, satellite radio receiver, AM/FM radio receiver, satellite television, portable music player, electronic device, portable computer, wireless radio, wireless telephone, portable digital video recorder, cellular telephone, mobile telephone, personal digital assistant (PDA), or combinations of the above, for example.

Flip phone 100 has a first mechanism arranged in hinge mechanism 130 for maintaining by use of a predetermined holding force the first and the second housing in a folded state or in a closed position. The flip phone 100 as shown is in a folded state or closed position, wherein the second housing 110 is planalry adjacent to the first housing 120. The second housing 110 is pivotally coupled to first housing 120 by a hinge mechanism 130 that has an axis of rotation 140. The hinge mechanism 130 may also be coupled to a slide enabling member 160 having a translational axis relative to hinge mechanism 130. The hinge mechanism 130 couples the second housing 110 to the first housing 120, allowing the second housing 110 to rotate relative to the first housing 120 about axis of rotation 140. A first mechanism by use of a predetermined holding force holds the second housing 110 and the first housing 120 in a closed position. Additionally, a second mechanism reduces or releases the respective housings from the predetermined holding force when stimulated by a first external force such as horizontal external force 170. The horizontal external force or push in the direction of the phone overcomes the predetermined holding force or an initial angle.

The horizontal external force 170 offsets the hinge mechanism 130 toward the speaker side to unlock a locking feature and thereby allowing the flip phone 100 to open under a spring tension force to a predetermined small angle as set by a cam pin profile. The horizontal force 170 or horizontal push and subsequent partial open of the flip of few degrees or in the range of 5 to 20 degrees gives the user leverage to pull on the bottom of the flip phone to open the flip or the second housing 110. To fully open flip phone 100, the user grabs the phone base in the area of the full thickness edges goal post and applies force 170 with his finger, this slides the flip in the direction of the force and unlocks the locking pin. The cam mechanism, once the locking pin is free, opens the flip to a partial open angle. The user then applies force 220 (FIG. 2) to open the phone from a partial open state to a fully opened state.

FIG. 2 is an illustration of partially opened flip phone 100 in accordance with a possible embodiment of the invention. To allow the user to carry flip phone 100 and not restrict the flip opening, the user grabs the phone by an area known as the goal post 150. Assuming the user employs the thumb and the middle finger to hold the flip phone, the index finger can be used to push horizontally against the phone. In a closed position, it is more natural for the index finger to push in the direction shown with respect to external horizontal force 170 rather than perpendicular to the phone such as when pushing on top of second housing 110. The horizontal force in conjunction with a second mechanism arranged in the area of hinge mechanism 130 causes the second housing 110 to move from the closed position to a position that would make it much easier to fully open flip phone 100. After horizontal external force 170 is applied, the second housing 110 translates in the direction of 170 and then the cam mechanism rotates the second housing relative to the first housing 120 to a predetermined angle that can be set by the use of a cam profile. A mechanism located in the vicinity of the goal post 150 or in the vicinity of the hinge mechanism 130 for achieving the initial angle can be a cam or a spring that causes the flip phone 100 to open a small angle.

The partial open position 210 can be an opening measuring 5 to 20 degrees. A second external force 220 can be applied to the flip phone 100 so as to move the first casing 110 from the partial open position 210 to a fully open position. As noted earlier the second external force 220 is from an object such as finger that pushes the second housing 110 in an upward direction causing the second housing to rotate towards a greater opening position.

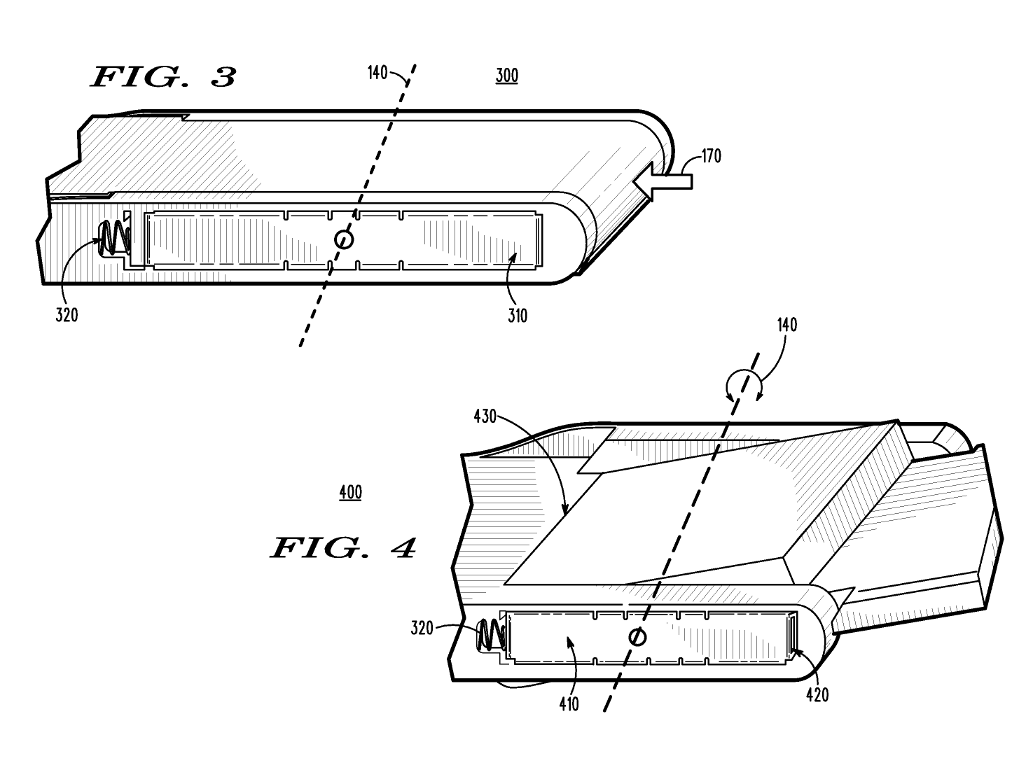

FIG. 3 is an illustration of a cam 300 with added spring in accordance to a possible embodiment of the invention. As shown flip phone 100 is in a closed position and with a cam mechanism 310 position being to the right. The user wishing to use the flip phone pushes or exerts an external horizontal force 170 in the direction of the phone. This push causes a spring mechanism 320 to compress. The spring mechanism 320 opposes the movement or push. The opposing force of the spring mechanism 320 is known as the force constant (K) or stiffness. The spring mechanism serves the purpose of countering the finger press and in the absence of the finger press, the spring mechanism 320 pushes a locking feature (not shown) to lock the second housing 110 and the first housing 120 in a closed position. In the flip closed position, the cam is pushed, via the shown added spring 320 to the far right side of the compartment wall.

FIG. 4 is an illustration of a flip open position with cam mechanism 410 displaced in the direction of spring element 320. Force 170 causes the cam mechanism 410 to translate, once it is translated far enough the cam mechanism 410 causes the flip to open to the partial open state. The translation or shift of cam mechanism 410 causes a gap 420 that is now visible on the right side. At the partial open state, the user is free to apply a force 220 to open the flip completely. The second external force 220 from an object such as a finger pushes the second housing 110 in an upward direction causing the second housing to rotate towards a greater opening position following the axis of rotation 140 of hinge assembly 130. A flip stop 430 halts the rotation of the second housing 110 at the open position.

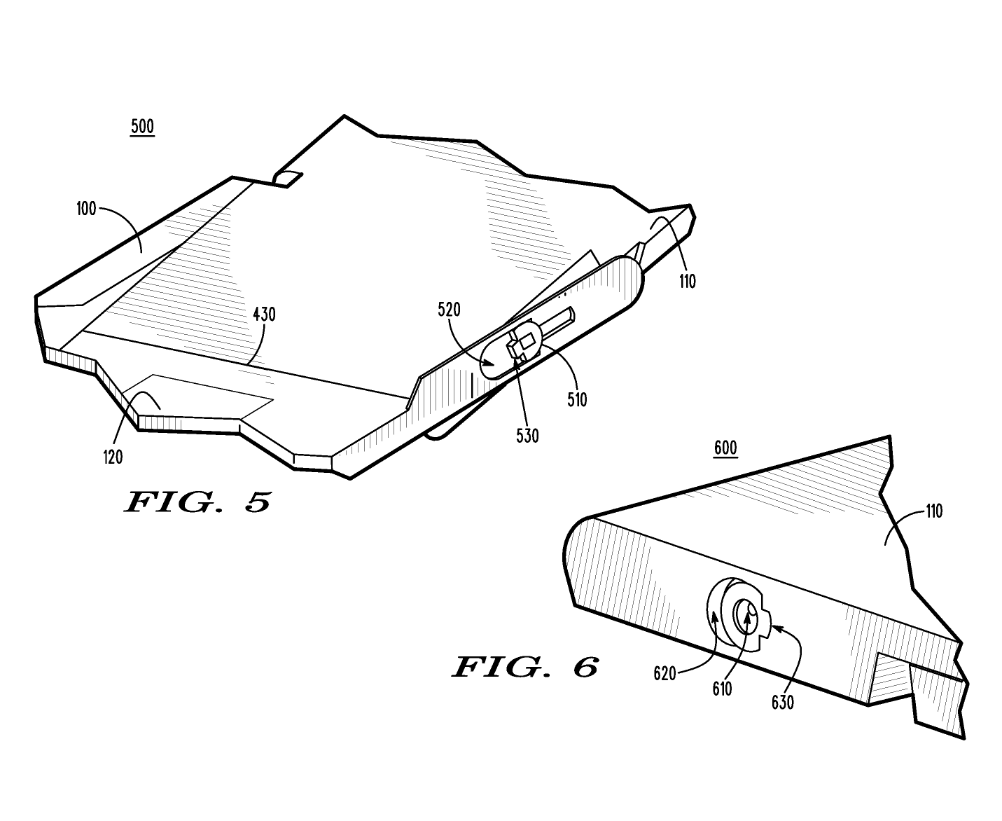

FIG. 5 is an illustration of a base pin locking feature 500 position in the flip portion of flip phone 100 in accordance to a possible embodiment. In particular, the base pin locking feature 500 comprises flip locking pin 510, base guide 520, and flip stop 430. Flip stop 430 halts the rotation of the second housing (flip) 110, at this juncture flip phone 100 is in a fully open position. Base guide 520 has an oval shape portion with an attached track or slot for receiving and for securing flip locking pin 510. Flip locking pin 510 is a semi oval shape protrusion with a notch or hook for position itself within the track or slot of base guide 520. Additionally, flip locking pin 510 in this embodiment is secured to the flip portion of the flip phone. Thus, a rotation of the flip portion causes a rotation at the flip locking pin. When the flip phone 100 is in the fully open position as shown, the flip locking pin 510 slides towards the narrow end of base guide 520 with the notch portion of the locking pin in the oval shape portion of base guide 520. When the flip phone is in a closed position, the notch or hook 530 of flip locking pin 510 positions itself into the track or slot of base guide 520. Once coupled the first housing (base) 120 and the second housing (flip) 110 are held together by the predetermined holding force created by flip locking pin 510 and base guide 520. The predetermined holding force is broken when a force such as external horizontal force 170 causes a decoupling of the flip locking pin and the base guide.

FIG. 6 is an illustration of a base pin locking feature 600 position in the base portion of flip phone 100 in accordance to a possible embodiment. In particular, the base pin locking feature 600 comprises a base locking pin 610, and flip guide 620. The base locking pin 610 is a semi oval shape protrusion with a notch or hook for position itself within a recess or track. Base Locking pin 610 is part of the first housing (base) 120 so it does not rotate with the movement of the flip portion of flip phone 100. The flip guide 620 is part of the flip portion so it rotates with the flip portion of flip phone 100. The flip guide is circular in shape with a recess or cavity 630 for receiving a protrusion or notch. The flip phone as shown is in the closed position. In the closed position, the hook part of base locking pin 610 is coupled to or is inside the recess part of flip guide 620. When so coupled the flip portion of flip phone is held in place by the predetermined force created by the interaction of the flip guide 620 and the base locking pin 610. To open the flip or to release the base locking pin 610 from the recess, the index finger presses down in the horizontal direction 170. The finger press countered by an added spring (not shown). The base locking pin 610 is then unlocked from the flip, the flip or second casing 110 rotates along rotation angle 140, the cam spring and cam pin forces the rotation of the flip over a partial angle, the partial angle is set by a cam pin profile to about 10 to 20 degrees or other desired angle.

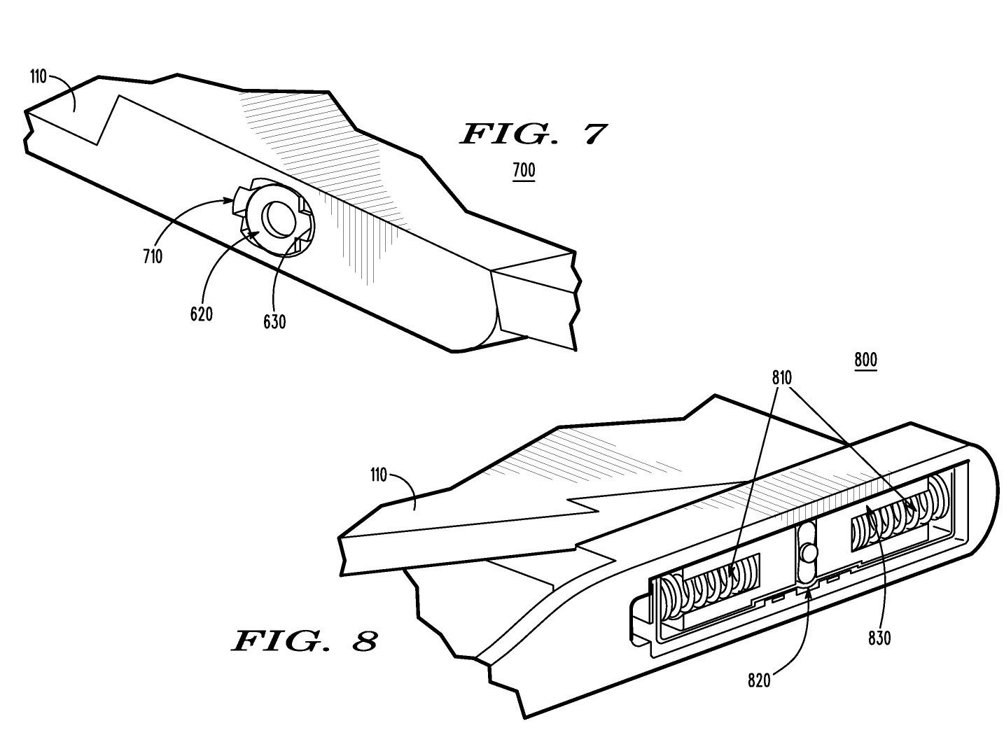

FIG. 7 is an illustration of base pin locking feature 700 after the flip guide 620 has rotated and it is no longer locking the second housing 110 to the first housing 120. The rotation is done by applying a vertical external force to the second housing 110 so as to cause the housing to move from a close position as shown with reference to FIG. 6 to an open position relative to the first housing. In the open position as shown the recess or cavity 630 of flip guide 620 is displaced by substantially 180 degrees. The new position of recess or cavity 630 is shown as 710. The protrusion of the base locking pin is now in the opposite side of cavity 630.

FIG. 8 is an illustration of cam mechanism 310 in accordance to a possible embodiment of the invention. In particular, cam mechanism 310 has a casing 830 for holding at least one spring 810, and a cam profile 820 or cam pin. As a general matter, a cam may be defined as a machine element having a curved outline or a curved groove that by oscillation or rotation motion gives a predetermined specified motion to another element. In the present arrangement cam pin 820 rotates by an amount proportional to the partial open position 210. When flip phone 100 is in the closed position cam pin 820 exerts a compression force (pushes) on springs 810. When the horizontal external force 170 is applied to flip phone 100, base pin locking feature 700 releases the flip and the cam pin 820 is allowed to rotate to the shown neutral position. The unlocking causes the flip to become free to rotate, a cam spring and cam pin forces the rotation of the flip over a partial angle as set by cam pin profile 820. Cam pin 820 rotates to a neutral position or to a point of equilibrium. Once the initial angle or partial open position is complete, the cam springs are inactive. The cam pin sets the partially open position. The cam pin determines the degree of the opening once the first external force is applied to the flip phone.

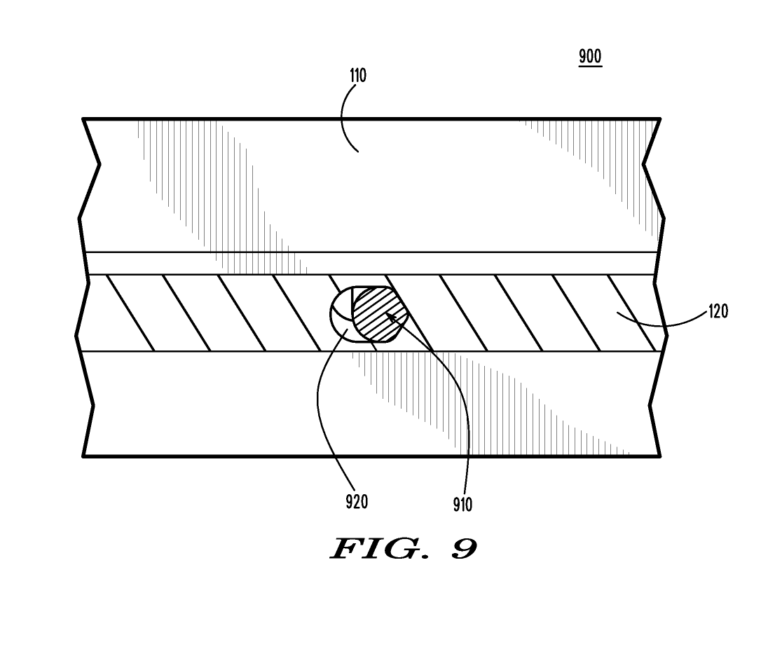

FIG. 9 is an illustration of a locking feature 900 of flip phone 100 in accordance to a possible embodiment. In this embodiment, the locking feature is a non-circular shaped cam coupled to the second housing (flip) 110 that has a complimentary receiving feature in the first housing (base) 120. The non-circular shaped cam prevents the flip from rotating by a frictional force between the cam surface 910 and the follower surface 920, thereby holding the phone in the closed configuration. The horizontal force may be applied and causing the flip portion to move horizontally as described above and the non-circular cam may be moved into a portion of the first housing 120 allowing it to rotate. The cam causes the flip to open to a partial open state. The vertical force may also be applied to the flip in the closed position such that the vertical force overcomes the frictional force of the cam follower combination and thereby moving the flip horizontally and rotating in a motion dictated by the cam follower configuration.

Other configurations of the described embodiments of the disclosure are part of the scope of this disclosure. For example, the principles of the disclosure may be applied to each individual user where each user may individually deploy such a system. This enables each user to utilize the benefits of the disclosure even if any one of the large number of possible applications do not need the functionality described herein. It does not necessarily need to be one system used by all end users. Accordingly, the appended claims and their legal equivalents should only define the disclosure, rather than any specific examples given.

We claim:

1. A method of manufacturing a flip open assist mechanism for opening a second housing moveably coupled to a first housing, comprising:
providing a first mechanism to receive a first external force along a first axis so as to cause the second housing to move from a closed position to a partial open position relative to the first housing; and
providing a second mechanism to receive a second external force along a second axis to cause the second housing to move from the partial open position to an open position relative to the first housing.

2. The method of claim 1, wherein the first and second housing are locked in the closed position with a base pin locking feature.

3. The method of claim 2, wherein the first external force causes the base pin locking feature to release the first and second housing from the closed position.

4. The method of claim 1, wherein the first external force operates through a cam mechanism with at least one spring and at least one cam pin to move the second housing from the closed position to the partial open position relative to the first housing.

5. The method of claim 4, wherein the cam pin sets how far the second housing has to travel to reach the partial open position.

6. The method of claim 1, the method further comprising:
providing a spring mechanism to counter the first external force and for pushing a base pin to lock the first and second housing in the closed position.

7. The method of claim 6, wherein movement from the closed position to a partial open position relative to the first housing is done through a hinge assembly.

8. An apparatus for opening a communication device, the apparatus comprising:
a first and a second housing connected to each other by a hinge mechanism;
a first mechanism arranged in the hinge mechanism for maintaining by use of a predetermined holding force the first and the second housing in a folded state;
a second mechanism arranged in the hinge mechanism for reducing the predetermined holding force when stimulated by a first external force along a first axis, wherein the first external force causes the first and second housing to a partial open state; and
a third mechanism arranged in the hinge mechanism for causing an open state in the communication device when stimulated by a second external force along a second axis.

9. The apparatus of claim 8, wherein the first mechanism is a base pin locking feature for locking the first and second housing in the folded state.

10. The apparatus of claim 9, wherein the first external force causes the base pin locking mechanism to release the first and second housing from the folded state.

11. The apparatus of claim 8, wherein the second mechanism is a cam mechanism with at least one spring and at least one cam pin.

12. The apparatus of claim 11, wherein the at least one spring and the at least one cam pin force the first and second housing to the partial open state.

13. The apparatus of claim 12, wherein the cam pin sets the partial open state.

14. The apparatus of claim 8, wherein the first external force is in a first direction and the second external force is in a second direction.

15. An electronic device comprising:
a first housing;
a second housing;
a hinge mechanism connected to the first and second housing, wherein the hinge mechanism is pivotally connected to the first housing; and
a flip open assist mechanism for moving the first housing to a partial open position when acted upon by a first external force.

16. The electronic device of claim 15, the flip open assist mechanism further comprising:
a first mechanism for maintaining by use of a predetermined holding force the first and the second housing in a closed position;
a second mechanism for releasing the predetermined holding force when stimulated by the first external force; and
a third mechanism for causing the first and second housing to a fully open position when stimulated by a second external force.

17. The electronic device of claim 16, the electronic device further comprising:
a base pin locking feature in the first mechanism for locking the first and second housing in the first position, wherein the first external force causes the base pin locking feature to release the first and second housing from the closed position.

18. The electronic device of claim 17, wherein the second mechanism is a cam mechanism with at least one spring and at least one cam pin.

19. The electronic device of claim 15, wherein flip open assist mechanism comprises at least one spring and at least one cam pin to move the first housing to the partial open position.

20. The electronic device of claim 19, wherein the cam pin sets the partially open position.
